(19) United States
(12) Patent Application Publication
(10) Pub. No.: US 2026/0158877 A1
(43) Pub. Date: Jun. 11, 2026

(54) HEAT PUMP SYSTEM FOR A HYBRID VEHICLE

(71) Applicants: HYUNDAI MOTOR COMPANY, Seoul (KR); KIA CORPORATION, Seoul (KR)

(72) Inventors: Yeong Jun Kim, Hwaseong-si (KR); Hochan An, Hwaseong-si (KR); Yeon Ho Kim, Hwaseong-si (KR); Gwi Taek Kim, Hwaseong-si (KR); Hoyoung Jeong, Hwaseong-si (KR); Man Hee Park, Hwaseong-si (KR); Jae Yeon Kim, Hwaseong-si (KR); Jeawan Kim, Hwaseong-si (KR)

(73) Assignees: HYUNDAI MOTOR COMPANY, Seoul (KR); KIA CORPORATION, Seoul (KR)

(21) Appl. No.: 19/256,904

(22) Filed: Jul. 1, 2025

(30) Foreign Application Priority Data
Dec. 6, 2024 (KR) 10-2024-0180991

(51) Int. Cl. B60H 1/32; B60H 1/00

(52) U.S. Cl. CPC B60H 1/32284; B60H 1/00278; B60H 1/004; B60H 1/00485

(57) ABSTRACT

A heat pump system for a hybrid vehicle is capable of performing the warming up of the engine and the vehicle interior heating while the ambient air temperature is low, improving the fuel efficiency by minimizing the engine operation, and improving the operation efficiency of the system by preventing the pressure drop of the circulating refrigerant. The heat pump system includes a first cooling apparatus, a second cooling apparatus, a vehicle interior heating device, a control valve, a first connection line, a second connection line, and an air conditioner unit, where the second line and the second connection line are respectively connected to the condenser so as to selectively circulate the first coolant and the second coolant.

### CROSS-REFERENCE TO RELATED APPLICATION

This application claims priority to and the benefit of Korean Patent Application No. 10-2024-0180991, filed with the Korean Intellectual Property Office on Dec. 6, 2024, the entire contents of which is incorporated herein by reference.

### FIELD

The present disclosure relates to a heat pump system for a hybrid vehicle, and more particularly, the present disclosure relates to a heat pump system for a hybrid vehicle applicable to a hybrid vehicle that uses an engine and a motor as power sources.

### BACKGROUND

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used unlike an air conditioner of a general vehicle, and an air conditioner used in the environment-friendly vehicle is generally called a heat pump system.

An electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Accordingly, in a hybrid vehicle according to the conventional scheme, in order to prevent heat generation of an engine, a motor, an electrical component, and a battery including a fuel cell, a battery cooling system needs to be configured as a separate closed circuit, together with a cooling system and a heat pump system.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, in a heat pump system for a hybrid vehicle according to the conventional scheme, when the external temperature is low, the vehicle interior heating needs to be performed only after warming up of the engine, so that the warming up of the engine and the vehicle interior heating may not be simultaneously performed, and the time required for the vehicle interior heating is increased.

In addition, in a heat pump system for a hybrid vehicle according to the conventional scheme, a frequent operation of the engine may be required for warming up of the engine, and accordingly, the amount of the engine operation and the operation time may be increased, thereby lowering the fuel efficiency.

In addition, in a heat pump system for a hybrid vehicle according to the conventional scheme, a pressure drop of the refrigerant circulating along the refrigerant line may occur in a heating and dehumidification mode of the vehicle interior, possibly causing a problem of deteriorating the overall performance and efficiency.

The above information disclosed in this Background section is only to enhance understanding of the background of the disclosure, and therefore it may contain information that does not form the prior art that is already known to one having ordinary skill in the art.

### SUMMARY

The present disclosure provides a heat pump system for a hybrid vehicle capable of performing the warming up of the engine and the vehicle interior heating while the ambient air temperature is low, improving the fuel efficiency by minimizing the engine operation, and improving the operation efficiency of the system by preventing the pressure drop of the circulating refrigerant.

In an embodiment of the present disclosure, a heat pump system for a hybrid vehicle includes a first cooling apparatus including a first line along which a first coolant circulates, an engine valve, a first radiator, and a first water pump. In particular, the first line is corrected to an engine, the engine valve, the first radiator, and the first water pump. The heat pump system further includes a second cooling apparatus including a second line along which a second coolant circulates, and an electrical component, a second radiator, and a second water pump connected through the second line. The heat pump system further includes a vehicle interior heating device including a third line having a first end connected to the engine valve, and a second end connected to the first water pump to selectively circulate the first coolant, and a heater core provided on the third line. The heat pump system further includes a control valve provided on the third line between the engine valve and the heater core. The heat pump system further includes a first connection line having a first end connected to the control valve, and a second end connected to the first line between the engine and the first water pump. The heat pump system further includes a second connection line having a first end connected to the control valve, and a second end connected to the third line between the control valve and the heater core. The heat pump system further includes an air conditioner unit including a refrigerant line along which a refrigerant circulates, a compressor, a condenser, a first expansion valve, a heat-exchanger, a second expansion valve, and an evaporator. In particular, the refrigerant line is configured to connect the compressor, the condenser, the first expansion valve, the heat-exchanger, the second expansion valve, and the evaporator. The second line and the second connection line are connected to the condenser so as to selectively circulate the first coolant and the second coolant.

The first expansion valve may be provided on the refrigerant line between the condenser and the heat-exchanger, and the second expansion valve may be provided on the refrigerant line between the heat-exchanger and the evaporator.

The heat pump system may include a first refrigerant connection line having a first end connected to the first expansion valve, and a second end connected to the refrigerant line between the second expansion valve and the evaporator. The heat pump system may further include a second refrigerant connection line having a first end connected to the second expansion valve, and a second end connected to the refrigerant line between the evaporator and the compressor.

In a cooling mode of the vehicle interior, the first expansion valve may close the first refrigerant connection line, and may introduce the refrigerant supplied from the condenser into the heat-exchanger through the refrigerant line without expansion.

In a cooling mode of the vehicle interior, the second expansion valve may close the second refrigerant connection line, may expand the refrigerant supplied from the heat-exchanger, and may introduce the expanded refrigerant to the evaporator through the refrigerant line.

In the vehicle interior heating-engine warm-up mode, the first expansion valve may close the first refrigerant connection line, and expand the refrigerant supplied from the condenser, and may introduce the expanded refrigerant to the heat-exchanger through the refrigerant line.

When dehumidification is required in the vehicle interior heating-engine warm-up mode or in the vehicle interior heating-engine warm-up mode, the second expansion valve may open the second refrigerant connection line, may close the refrigerant line connected to the evaporator, and may allow the refrigerant supplied from the heat-exchanger to the second refrigerant connection line without expansion.

When dehumidification is required in the vehicle interior heating-engine warm-up mode, the first expansion valve may be configured to open the first refrigerant connection line, expand the refrigerant supplied from the condenser, and allow the expanded refrigerant to respectively flow along the refrigerant line and the first refrigerant connection line.

When dehumidification is required in the vehicle interior heating-engine warm-up mode or the vehicle interior heating-engine warm-up mode, the engine valve may close the first line connected to the first radiator so that the first coolant is not supplied to the engine.

When dehumidification is required in the vehicle interior heating-engine warm-up mode or in the vehicle interior heating-engine warm-up mode, the control valve may open the first and second connection lines so that the first connection line and the second connection line may be connected, and may close a portion of the third line connecting the engine valve and a second end of the second connection line.

The control valve may be configured to, in a cooling mode of the vehicle interior, close the third line, the first connection line, and the second connection line, and in a heating mode of the vehicle interior, open the third line, and close the first connection line and the second connection line.

In a heating mode of the vehicle interior while the warming up of the engine is completed, the air conditioner unit may stop operating.

In the vehicle interior heating-engine warm-up mode, the condenser may heat-exchange the refrigerant supplied from the compressor with the first coolant supplied through the second connection line, to increase the temperature of the first coolant, so that the high-temperature first coolant is supplied to the heater core.

The first and second expansion valves may be 3-way electronic expansion valves configured to selectively expand the refrigerant while controlling a flowing movement of the refrigerant.

An accumulator may be provided on the refrigerant line between the evaporator and the compressor.

The heat pump system may further include a sub-heat-exchanger provided on the refrigerant line connecting the condenser and the first expansion valve, and the refrigerant line connecting the evaporator and the compressor, and configured to heat-exchange the refrigerant supplied from the condenser through the refrigerant line, and the refrigerant supplied from the evaporator, with each other.

The heater core may be an air-cooled heat-exchanger configured to, in the vehicle interior heating-engine warm-up mode, heat-exchange the first coolant supplied from the condenser with an ambient air, and supply the heated ambient air to the vehicle interior, and in a heating mode of the vehicle interior, heat-exchange the first coolant supplied from the engine with the ambient air, and supply the heated ambient air to the vehicle interior.

The condenser may be a water-cooled heat-exchanger, and the heat-exchanger may be an air-cooled heat-exchanger.

The heat-exchanger may be configured to condense or evaporate the interiorly introduced refrigerant through heat-exchange with an ambient air, according to a selective operation of the first expansion valve.

The control valve may be a 4-way valve that can control a flow rate distribution and a flowing movement of the supplied first coolant.

As described above, according to a heat pump system for a hybrid vehicle according to an embodiment of the present disclosure, by performing the warming up of the engine and the vehicle interior heating in an early stage of driving the vehicle while the ambient air temperature is low, the engine may be warmed up more rapidly, and the overall performance and efficiency of the system may be improved.

In addition, according to the present disclosure, a water-cooled heat-exchanger configured to heat-exchange the refrigerant supplied from the compressor with the coolant may be applied, and by supplying the coolant heated increased through heat-exchange with the refrigerant to the heating device, the vehicle interior may be efficiently heated even while warming up the engine.

In addition, according to the present disclosure, by blocking the coolant from being introduced into the engine when warming up the engine, the engine can be warmed up more rapidly so that the fuel efficiency can be improved by minimizing the engine operation compared to the conventional scheme.

In addition, according to the present disclosure, by using the coolant having recollected the heat of the engine in heating of the vehicle interior, without operating the air conditioner unit, the heating efficiency and performance may be further improved, and the compressor operation may be minimized, so that an unnecessary power consumption can be prevented.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram of a heat pump system for a hybrid vehicle according to an embodiment of the present disclosure.

FIG. 2 is an operation diagram of a heat pump system for a hybrid vehicle according to an embodiment of the present disclosure, for a cooling mode of the vehicle interior.

FIG. 3 is an operation diagram of a heat pump system for a hybrid vehicle according to an embodiment of the present disclosure, for a heating-engine warm-up mode of the vehicle interior.

FIG. 4 is an operation diagram of a heat pump system for a hybrid vehicle according to an embodiment of the present disclosure, when dehumidification is required in a vehicle interior heating-engine warm-up mode.

FIG. 5 is an operation diagram of a heat pump system for a hybrid vehicle according to an embodiment of the present disclosure, for a heating mode of the vehicle interior.

The drawings described herein are for illustration purposes only and are not intended to limit the scope of the present disclosure in any way.

### DETAILED DESCRIPTION

An embodiment of the present disclosure will hereinafter be described in detail with reference to the accompanying drawings.

Embodiments of the present disclosure in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise”, “have”, “include”, and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

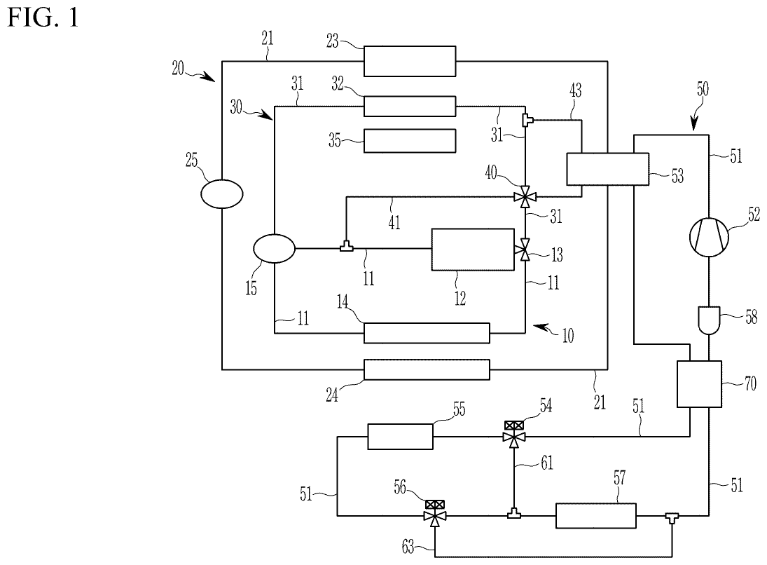

FIG. 1 is a block diagram of a heat pump system for a hybrid vehicle according to an embodiment of the present disclosure.

When the ambient air temperature is low, a heat pump system for a hybrid vehicle according to an embodiment of the present disclosure may perform warming up of an engine 12 and heating of a vehicle interior, and improve the fuel efficiency by minimizing the operation of the engine 12, and prevent a pressure drop of a circulating refrigerant to improve the operation efficiency of the system.

The heat pump system may be applied to a hybrid vehicle using the engine 12 and a motor (not shown) as power sources. A first cooling apparatus 10 for supplying the first coolant to the engine 12, a second cooling apparatus 20 for supplying the second coolant to an electrical component 23, a vehicle interior heating device 30 for heating the vehicle interior by using the first coolant, and an air conditioner unit 50 for cooling the vehicle interior may be interconnected with each other.

In other words, referring to FIG. 1, the heat pump system may include the first cooling apparatus 10, the second cooling apparatus 20, the vehicle interior heating device 30, a control valve 40, a first connection line 41, a second connection line 43, and the air conditioner unit 50.

The first cooling apparatus 10 may include a first line 11 through which the first coolant circulates, and the engine 12, an engine valve 13, a first radiator 14, and a first water pump 15 connected through the first line 11.

The first radiator 14 may be disposed at the front of the vehicle. A cooling fan (not shown) may be provided on a downstream side of the first radiator 14. Accordingly, the first radiator 14 may cool the first coolant through an operation of the cooling fan and heat-exchange with the ambient air.

The engine 12 may be connected to the first radiator 14 through the first line 11, so as to allow the coolant to circulate therein. The engine valve 13 may be integrally provided in the engine 12.

In the vehicle interior heating-engine warm-up mode, or when dehumidification is required in the vehicle interior heating-engine warm-up mode, the engine valve 13 may close the first line 11 connected to the first radiator 14 so that the first coolant is not supplied to the engine 12.

The first cooling apparatus 10 configured as such may circulate the first coolant along the first line 11 through an operation of the first water pump 15, so as to adjust the temperature of the engine 12.

The second cooling apparatus 20 may include a second line 21 through which the second coolant circulates, and the electrical component 23, a second radiator 24, and a second water pump 25 connected through the second line 21.

The second radiator 24 may be disposed in front of the first radiator 14, and may cool the second coolant through the operation of the cooling fan and heat-exchange with the ambient air.

The electrical component 23 may include an electrical power control unit (EPCU), a motor, an inverter, an on-board charger (OBC), an autonomous driving controller, or the like.

The second cooling apparatus 20 configured as such may circulate the second coolant along the second line 21 through an operation of the second water pump 25, so as to adjust the temperature of the electrical component 23.

In an embodiment of the present disclosure, the vehicle interior heating device 30 may include a third line 31 through which the first coolant selectively circulates, and a heater core 32 provided on the third line 31.

A first end of the third line 31 may be connected to the engine valve 13. A second end of the third line 31 may be connected to the first water pump 15.

Accordingly, the first coolant supplied from the engine 12 may selectively flow along the third line 31 by the engine valve 13 and the first water pump 15.

The heater core 32 may be provided inside a HVAC module (not shown). Accordingly, the high-temperature first coolant supplied through the third line 31 may increase the temperature of the ambient air passing through the heater core 32.

The introduced ambient air may be converted into a high-temperature state while passing through the heater core 32 and then introduced into the vehicle interior, thereby implementing heating of the vehicle interior.

In other words, in a heating mode of the vehicle interior, the heater core 32 may be an air-cooled heat-exchanger configured to heat-exchange the first coolant supplied from the engine 12 with the ambient air, and supply the heated ambient air to the vehicle interior.

The vehicle interior heating device 30 may further include an air heater 35 for increasing the temperature of the ambient air introduced into the vehicle interior.

The air heater 35 may be disposed inside the HVAC module (not pictured) and on a downstream side of the heater core 32 toward the vehicle interior, so as to selectively heat the ambient air having passed through the heater core 32.

When heating the vehicle interior, the vehicle interior heating device 30 configured as such may heat the vehicle interior by supplying the high-temperature first coolant to the heater core 32 through the operation of the first water pump 15.

In an embodiment of the present disclosure, the control valve 40 may be provided on the third line 31 between the engine valve 13 and the heater core 32.

A first end of the first connection line 41 may be connected to the control valve 40. A second end of the first connection line 41 may be connected to the first line 11 between the engine 12 and the first water pump 15.

In an embodiment of the present disclosure, a first end of the second connection line 43 is connected to the control valve 40. A second end of the second connection line 43 may be connected to the third line 31 between the control valve 40 and the heater core 32.

The control valve 40 may be a 4-way valve that can control the flow rate distribution and flowing movement of the supplied first coolant.

In the vehicle interior heating-engine warm-up mode, or when dehumidification is required in the vehicle interior heating-engine warm-up mode, the control valve 40 configured as such may open the first connection line 41 and the second connection line 43 so that the first connection line 41 and the second connection line 43 are connected. The control valve 40 may close a portion of the third line 31 connecting the engine valve 13 and the second end of the second connection line 43.

In a cooling mode of the vehicle interior, the control valve 40 may close the third line 31, the first connection line 41, and the second connection line 43.

In addition, the air conditioner unit 50 may include a refrigerant line 51 through which the refrigerant circulates, and a compressor 52, a condenser 53, a first expansion valve 54, a heat-exchanger 55, a second expansion valve 56, and an evaporator 57 connected through the refrigerant line 51.

The compressor 52 may compress the supplied refrigerant and allow the compressed refrigerant to flow through the refrigerant line 51 so that the refrigerant circulates along the refrigerant line 51.

The condenser 53 may be connected to the compressor 52 through the refrigerant line 51. The second line 21 and the second connection line 43 may be respectively connected to the condenser 53 so as to selectively circulate the first coolant and the second coolant respectively.

Accordingly, the condenser 53 may heat-exchange the first coolant or the second coolant supplied through at least one of the second line 21 and the second connection line 43 with the refrigerant supplied from the compressor 52.

In the vehicle interior heating-engine warm-up mode, the condenser 53 may heat-exchange the refrigerant supplied from the compressor 52 with the first coolant supplied through the second connection line 43, to increase the temperature of the first coolant, so that the high-temperature first coolant is supplied to the heater core 32.

In other words, the condenser 53 may be a water-cooled heat-exchanger configured to heat-exchange the introduced refrigerant and the coolant with each other.

In the vehicle interior heating-engine warm-up mode, the heater core 32 may heat-exchange the first coolant supplied from the condenser 53 with the ambient air, and may supply the heated ambient air to the vehicle interior.

The first expansion valve 54 may be connected to the condenser 53 through the refrigerant line 51. The first expansion valve 54 may selectively expand the refrigerant supplied from the condenser 53.

In an embodiment of the present disclosure, the heat-exchanger 55 may be connected to the first expansion valve 54 through the refrigerant line 51.

The heat-exchanger 55 may condense or evaporate the interiorly introduced refrigerant through heat-exchange with the ambient air according to the selective operation of the first expansion valve 54.

The heat-exchanger 55 may be disposed at the front of the second radiator 24. The heat-exchanger 55 may be an air-cooled heat-exchanger configured to heat-exchange the introduced refrigerant with the ambient air.

The first expansion valve 54 may be provided on the refrigerant line 51 between the condenser 53 and the heat-exchanger 55.

In an embodiment of the present disclosure, the second expansion valve 56 may be connected to the heat-exchanger 55 through the refrigerant line 51. The second expansion valve 56 may selectively expand the refrigerant supplied from the heat-exchanger 55.

The second expansion valve 56 may be provided on the refrigerant line 51 between the heat-exchanger 55 and the evaporator 57.

The first expansion valve 54 and the second expansion valve 56 configured as such may be 3-way electronic expansion valves configured to selectively expand the refrigerant, while controlling a flowing movement of the refrigerant.

An embodiment of the present disclosure takes an example in which the first expansion valve 54 and the second expansion valve 56 are configured as electronic expansion valves, but is not limited thereto, and the first expansion valve 54 and the second expansion valve 56 may be configured as a valve module in which a mechanical expansion valve and a 3-way valve is integrated.

The evaporator 57 may be connected to the second expansion valve 56 through the refrigerant line 51. In addition, the evaporator 57 may be connected to the compressor 52 through the refrigerant line 51. The evaporator 57 configured as such may be provided inside the HVAC module, together with the heater core 32.

An opening/closing door (not shown) configured to adjust the ambient air having passed through the evaporator 57 to be selectively introduced into the heater core 32 may be internally provided in the interior of the HVAC module between the evaporator 57 and the heater core 32.

When dehumidification is required in the vehicle interior heating-engine warm-up mode or in the vehicle interior heating-engine warm-up mode, or in the heating mode of the vehicle interior, the opening/closing door may be opened, so that the ambient air having passed through the evaporator 57 is introduced into the heater core 32.

In the cooling mode of the vehicle interior, the opening/closing door may close a side toward the heater core 32 so that the ambient air cooled while passing through the evaporator 57 is directly introduced into the vehicle interior.

The heater core 32 may be an air-cooled heat-exchanger configured to heat-exchange the first coolant supplied from the engine 12 through the second connection line 43, or the first coolant supplied from the condenser 53 through the first connection line 41 and the second connection line 43 with the ambient air, and supply the heated ambient air to the vehicle interior.

An accumulator 58 may be provided on the refrigerant line 51 between the evaporator 57 and the compressor 52. The accumulator 58 may supply only the gaseous refrigerant to the compressor 52, thereby improving the efficiency and durability of the compressor 52.

The air conditioner unit 50 configured as such may further include a first refrigerant connection line 61 and a second refrigerant connection line 63.

A first end of the first refrigerant connection line 61 may be connected to the first expansion valve 54. A second end of the first refrigerant connection line 61 may be connected to the refrigerant line 51 between the second expansion valve 56 and the evaporator 57.

In addition, a first end of the second refrigerant connection line 63 may be connected to the second expansion valve 56. A second end of the second refrigerant connection line 63 may be connected to the refrigerant line 51 between the evaporator 57 and the compressor 52.

The second end of the second refrigerant connection line 63 may be connected to the refrigerant line 51 between the evaporator 57 and the accumulator 58.

An operation of the first expansion valve 54 and the second expansion valve 56 in the air conditioner unit 50 configured as such is hereinafter described in detail.

In the cooling mode of the vehicle interior, the first expansion valve 54 may close the first refrigerant connection line 61. The first expansion valve 54 may allow the refrigerant supplied from the condenser 53 to flow into the heat-exchanger 55 without expansion through the refrigerant line 51.

The heat-exchanger 55 may condense the refrigerant supplied from the first expansion valve 54 through heat-exchange with the ambient air.

In the vehicle interior heating-engine warm-up mode, the first expansion valve 54 may close the first refrigerant connection line 61. The first expansion valve 54 may expand the refrigerant supplied from the condenser 53, and may allow the expanded refrigerant to flow into the heat-exchanger 55 through the refrigerant line 51.

When dehumidification is required in the vehicle interior heating-engine warm-up mode, the first expansion valve 54 may open the first refrigerant connection line 61. The first expansion valve 54 may expand the refrigerant supplied from the condenser 53, and may allow the expanded refrigerant to respectively flow along the refrigerant line 51 and the first refrigerant connection line 61.

Accordingly, in the vehicle interior heating-engine warm-up mode, or when dehumidification is required in the vehicle interior heating-engine warm-up mode, the heat-exchanger 55 may evaporate the expanded refrigerant introduced from the first expansion valve 54 through heat-exchange with the ambient air.

In addition, in the cooling mode of the vehicle interior, the second expansion valve 56 may close the second refrigerant connection line 63. The second expansion valve 56 may expand the refrigerant supplied from the heat-exchanger 55, and may allow the expanded refrigerant to flow into the evaporator 57 through the refrigerant line 51.

In the vehicle interior heating-engine warm-up mode, or when dehumidification is required in the vehicle interior heating-engine warm-up mode, the second expansion valve 56 may open the second refrigerant connection line 63, and may close the refrigerant line 51 connected to the evaporator 57.

The second expansion valve 56 may allow the refrigerant supplied from the heat-exchanger 55 to the second refrigerant connection line 63 without expansion.

The air conditioner unit 50 may further include a sub-heat-exchanger 70.

The sub-heat-exchanger 70 may be provided on the refrigerant line 51 connecting the condenser 53 and the first expansion valve 54, and the refrigerant line 51 connecting the evaporator 57 and the accumulator 58.

The sub-heat-exchanger 70 may heat-exchange the refrigerant supplied from the condenser 53 through the refrigerant line 51, and the refrigerant supplied from the evaporator 57, with each other.

The sub-heat-exchanger 70 may be a double-tube heat-exchanger or plate-type heat-exchanger configured to heat-exchange the refrigerants having different temperatures with each other.

When the warming up of the engine 12 is completed in the heating mode of the vehicle interior, an operation of the air conditioner unit 50 configured as such may be stopped.

The vehicle interior heating device 30 may heat the vehicle interior by using the first coolant having increased its temperature while passing through the engine 12.

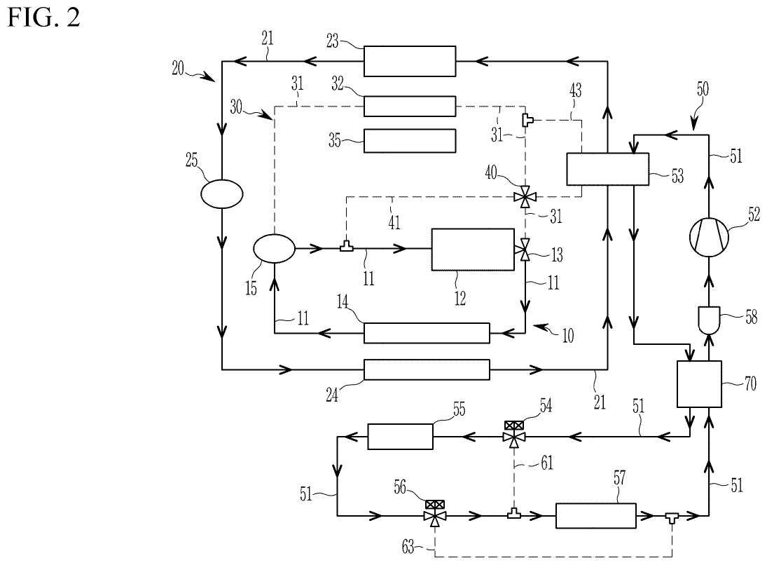

Hereinafter, an operation and action of a heat pump system for a hybrid vehicle according to an embodiment of the present disclosure configured as described above are described in detail with reference to FIGS. 2-5.

An operation for the cooling mode of the vehicle interior is described in detail with reference to FIG. 2.

FIG. 2 is an operation diagram of a heat pump system for a hybrid vehicle according to an embodiment of the present disclosure, for the cooling mode of the vehicle interior.

Referring to FIG. 2, the first cooling apparatus 10 may operate the first water pump 15 to circulate the first coolant through the first line 11, to cool the engine 12.

The control valve 40 may close the third line 31, the first connection line 41, and the second connection line 43.

Accordingly, the first coolant cooled in the first radiator 14 may smoothly cool the engine 12.

The second cooling apparatus 20 may operate the second water pump 25 to circulate the second coolant through the second line 21 to cool the electrical component 23. Accordingly, the second coolant cooled in the second radiator 24 may smoothly cool the electrical component 23.

The third line 31 in the vehicle interior heating device 30 may be closed by the operation of the engine valve 13 and the control valve 40 so that the high-temperature first coolant is not supplied to the heater core 32. Accordingly, the first coolant may stop flowing through the third line 31.

In such a state, the compressor 52 may be operated to cool the vehicle interior. The refrigerant may circulate along the refrigerant line 51.

The first expansion valve 54 may open the refrigerant line 51 connecting the condenser 53 and the heat-exchanger 55, and may close the first refrigerant connection line 61.

The first expansion valve 54 may allow the refrigerant having passed through the sub-heat-exchanger 70 from the condenser 53 to flow into the heat-exchanger 55 without expansion through the refrigerant line 51.

In other words, the first expansion valve 54 may allow the refrigerant supplied from the compressor 52 sequentially through the condenser 53 and the sub-heat-exchanger 70 to flow to the refrigerant line 51 without expansion.

In addition, the second expansion valve 56 may open the refrigerant line 51 connected to the heat-exchanger 55 and the refrigerant line 51 connected to the evaporator 57 so that the refrigerant having passed through the heat-exchanger 55 is supplied to the evaporator 57, and may close the second refrigerant connection line 63.

The second expansion valve 56 may expand the refrigerant so that the expanded refrigerant is supplied to the evaporator 57. In other words, the second expansion valve 56 may expand the refrigerant supplied from the heat-exchanger 55, and may allow the expanded refrigerant to flow into the evaporator 57 through the refrigerant line 51.

Accordingly, the refrigerant supplied from the compressor 52 to the condenser 53 may be primarily condensed while heat-exchanging with the second coolant passing through the condenser 53 along the second line 21.

The refrigerant discharged from the condenser 53 may be introduced into the sub-heat-exchanger 70 along the refrigerant line 51. The refrigerant condensed in the condenser 53 may be secondarily condensed through heat-exchange with the refrigerant introduced from the evaporator 57 while passing through the sub-heat-exchanger 70.

The refrigerant secondarily condensed in the sub-heat-exchanger 70 may pass through the first expansion valve 54, to be then introduced into the heat-exchanger 55 along the refrigerant line 51. The refrigerant introduced into the heat-exchanger 55 may be condensed through heat-exchange with the ambient air, for the third time.

The refrigerant discharged from the heat-exchanger 55 may be introduced into the evaporator 57 along the refrigerant line 51 while being expanded in the second expansion valve 56.

The refrigerant having passed through the evaporator 57 may pass through the sub-heat-exchanger 70, to be then supplied to the accumulator 58. The refrigerant supplied to the accumulator 58 may be separated into gas and liquid, and the gaseous refrigerant among the refrigerant separated into gas and liquid may be introduced into the compressor 52.

In other words, the refrigerant discharged from the compressor 52 may flow along the refrigerant line 51 to cool the vehicle interior, and may repeatedly perform the above-described operations, while sequentially passing through the condenser 53, the sub-heat-exchanger 70, the first expansion valve 54, the heat-exchanger 55, the second expansion valve 56, the evaporator 57, the sub-heat-exchanger 70, and the accumulator 58.

The ambient air introduced into the HVAC module may be cooled by the low-temperature refrigerant introduced into the evaporator 57 while passing through the evaporator 57.

The ambient air cooled while passing through the evaporator 57 may pass through the heater core 32 that is not supplied with the coolant to be directly introduced into the vehicle interior, thereby cooling the vehicle interior.

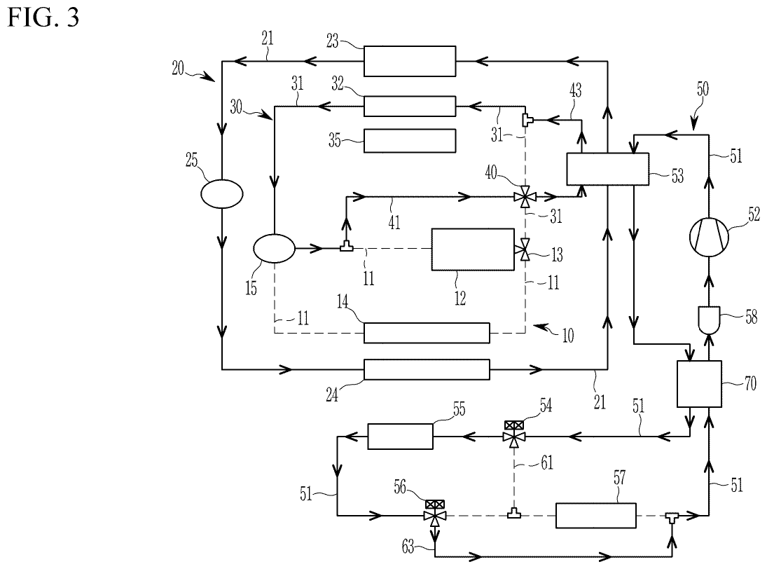

In an embodiment of the present disclosure, an operation in the vehicle interior heating-engine warm-up mode is described in detail with reference to FIG. 3.

FIG. 3 is an operation diagram of a heat pump system for a hybrid vehicle according to an embodiment of the present disclosure, for the vehicle interior heating-engine warm-up mode.

Referring to FIG. 3, the heat pump system may heat the vehicle interior while the external temperature is low, and rapidly warm up the engine 12.

In the first cooling apparatus 10, the first line 11 may be closed by the engine valve 13 so that the first coolant is not supplied to the engine 12. Accordingly, the first coolant may not flow along the first line 11.

In other words, the engine valve 13 may close the first line 11 connected to the first radiator 14 so that the first coolant is not supplied to the engine 12.

Accordingly, the engine 12 may be operated while the first coolant does not flow, thereby being able to be warmed up more rapidly.

In an embodiment of the present disclosure, the second cooling apparatus 20 may operate the second water pump 25 to circulate the second coolant through the second line 21 to cool the electrical component 23.

Accordingly, the second coolant cooled in the second radiator 24 may smoothly cool the electrical component 23.

The control valve 40 may open the first connection line 41 and the second connection line 43 so that the first connection line 41 and the second connection line 43 are connected. The control valve 40 may close a portion of the third line 31 connecting the engine valve 13 and the second end of the second connection line 43.

Accordingly, in the vehicle interior heating device 30, the first coolant may be supplied to the heater core 32 while circulating along a portion of the first line 11 connecting the second end of the first connection line 41 and the first water pump 15, and along the first connection line 41, the second connection line 43, and the opened third line 31, by the operation of the first water pump 15.

In such a state, the compressor 52 may be operated to heat the vehicle interior. The refrigerant may circulate along the refrigerant line 51.

The first expansion valve 54 may open the refrigerant line 51 connecting the condenser 53 and the heat-exchanger 55, and may close the first refrigerant connection line 61.

The first expansion valve 54 may expand the refrigerant having passed through the sub-heat-exchanger 70 from the condenser 53, and may allow the expanded refrigerant to flow into the heat-exchanger 55 through the refrigerant line 51.

In other words, the first expansion valve 54 may expand the refrigerant supplied from the compressor 52 sequentially through the condenser 53 and the sub-heat-exchanger 70 and allow the expand refrigerant to flow to the refrigerant line 51.

In addition, the second expansion valve 56 may close the refrigerant line 51 connected to the evaporator 57 so that the refrigerant having passed through the heat-exchanger 55 is not supplied into the evaporator 57, and may open the second refrigerant connection line 63.

The second expansion valve 56 may allow the refrigerant supplied from the heat-exchanger 55 to flow along the second refrigerant connection line 63 without expansion.

Accordingly, the refrigerant supplied from the compressor 52 to the condenser 53 may be primarily condensed while being respectively heat-exchanged with the first coolant passing through the condenser 53 along the second connection line 43, and the second coolant passing through the condenser 53 along the second line 21.

In other words, in a heating-and-engine warmup mode, the condenser 53 may heat-exchange the refrigerant supplied from the compressor 52 with the first coolant supplied through the second connection line 43, to increase the temperature of the first coolant, so that the high-temperature first coolant is supplied to the heater core 32.

The first coolant heated while passing through the condenser 53 may be introduced into the heater core 32 along the second connection line 43 and the third line 31. The heater core 32 may heat-exchange the first coolant supplied from the condenser 53 with the ambient air, and may supply the heated ambient air to the vehicle interior.

Accordingly, the heater core 32 can rapidly increase the temperature of the vehicle interior, thereby enabling smooth heating.

The refrigerant discharged from the condenser 53 may be introduced into the sub-heat-exchanger 70 along the refrigerant line 51. The refrigerant condensed in the condenser 53 may be secondarily condensed through heat-exchange with the refrigerant introduced from the heat-exchanger 55 through a portion of the refrigerant line 51 and the second refrigerant connection line 63 while passing through the sub-heat-exchanger 70.

The refrigerant secondarily condensed in the sub-heat-exchanger 70 may be introduced into the heat-exchanger 55 along the refrigerant line 51 while being expanded in the first expansion valve 54. The refrigerant introduced into the heat-exchanger 55 may be evaporated through heat-exchange with the ambient air.

Accordingly, the heat-exchanger 55 may recollect an ambient air heat while evaporating the expanded refrigerant through heat-exchange with the ambient air.

The refrigerant discharged from the heat-exchanger 55 may pass through the second expansion valve 56, and then flow along the second refrigerant connection line 63. The refrigerant flowing through the second refrigerant connection line 63 may pass through the sub-heat-exchanger 70 along the refrigerant line 51, to be then supplied to the accumulator 58.

The refrigerant supplied to the accumulator 58 may be separated into gas and liquid, and the gaseous refrigerant among the refrigerant separated into gas and liquid may be introduced into the compressor 52.

In other words, the refrigerant discharged from the compressor 52 may flow along the refrigerant line 51 and the second refrigerant connection line 63 to heat the vehicle interior, and may repeatedly perform the above-described operations, while sequentially passing through the condenser 53, the sub-heat-exchanger 70, the first expansion valve 54, the heat-exchanger 55, the second expansion valve 56, the sub-heat-exchanger 70, the accumulator 58.

The ambient air introduced into the HVAC module may be introduced in an uncooled state of having been not cooled while passing through the evaporator 57 into which the refrigerant is not introduced. The introduced ambient air may be converted into a high-temperature state while passing through the heater core 32 and then introduced into the vehicle interior, thereby implementing heating of the vehicle interior.

In other words, a heat pump system according to an embodiment of the present disclosure may recollect heat from a high-temperature refrigerant passing through the condenser 53 as well as the ambient air heat, and use it for heating the vehicle interior, so that the power consumption of the compressor 52 may be reduced, and the heating efficiency may be improved.

In addition, the first coolant may be blocked from flowing to the engine 12, thereby rapidly warming up the engine 12.

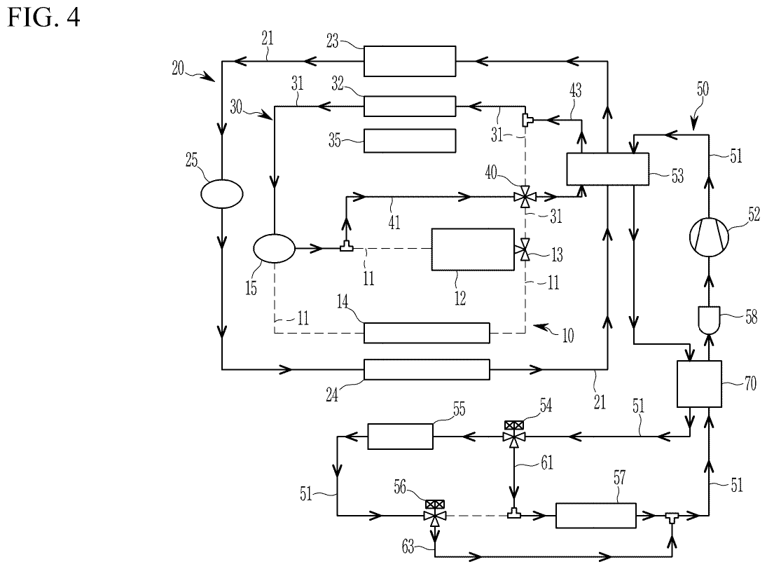

In an embodiment of the present disclosure, an operation when dehumidification is required in the vehicle interior heating-engine warm-up mode is described in detail with reference to FIG. 4.

FIG. 4 is an operation diagram of a heat pump system for a hybrid vehicle according to an embodiment of the present disclosure, when dehumidification is required in the vehicle interior heating-engine warm-up mode.

Referring to FIG. 4, the heat pump system may heat the vehicle interior while the external temperature is low, and rapidly warm up the engine 12, and dehumidify the vehicle interior.

In the first cooling apparatus 10, the first line 11 may be closed by the engine valve 13 so that the first coolant is not supplied to the engine 12. Accordingly, the first coolant may not flow along the first line 11.

In other words, the engine valve 13 may close the first line 11 connected to the first radiator 14 so that the first coolant is not supplied to the engine 12.

Accordingly, the engine 12 may be operated while the first coolant does not flow, thereby being able to be warmed up more rapidly.

In an embodiment of the present disclosure, the second cooling apparatus 20 may operate the second water pump 25 so as to circulate the second coolant through the second line 21 so as to cool the electrical component 23.

Accordingly, the second coolant cooled in the second radiator 24 may smoothly cool the electrical component 23.

The control valve 40 may open the first connection line 41 and the second connection line 43 so that the first connection line 41 and the second connection line 43 are connected. At the same time, the control valve 40 may close a portion of the third line 31 connecting the engine valve 13 and the second end of the second connection line 43.

Accordingly, in the vehicle interior heating device 30, the first coolant may be supplied to the heater core 32 while circulating along a portion of the first line 11 connecting the second end of the first connection line 41 and the first water pump 15, and along the first connection line 41, the second connection line 43, and the opened third line 31, by the operation of the first water pump 15.

In such a state, the compressor 52 may be operated to heat the vehicle interior. The refrigerant may circulate along the refrigerant line 51.

The first expansion valve 54 may open the refrigerant line 51 connecting the condenser 53 and the heat-exchanger 55, and may open the first refrigerant connection line 61.

The first expansion valve 54 may expand the refrigerant having passed through the sub-heat-exchanger 70 from the condenser 53.

In addition, the first expansion valve 54 may allow a partial refrigerant among the expanded refrigerant to flow into the heat-exchanger 55 through the refrigerant line 51, and may allow a remaining refrigerant among the expanded refrigerant to flow to the first refrigerant connection line 61.

In other words, the first expansion valve 54 may expand the refrigerant supplied from the compressor 52 sequentially through the condenser 53 and the sub-heat-exchanger 70 and allow the expanded refrigerant to respectively flow along the refrigerant line 51 and the first refrigerant connection line 61.

In addition, the second expansion valve 56 may close the refrigerant line 51 connected to the evaporator 57 so that the refrigerant having passed through the heat-exchanger 55 is not supplied into the evaporator 57, and may open the second refrigerant connection line 63.

The second expansion valve 56 may allow the refrigerant supplied from the heat-exchanger 55 to flow along the second refrigerant connection line 63 without expansion.

Accordingly, the refrigerant supplied from the compressor 52 to the condenser 53 may be primarily condensed while being respectively heat-exchanged with the first coolant passing through the condenser 53 along the second connection line 43, and the second coolant passing through the condenser 53 along the second line 21.

In other words, in a heating-and-engine warmup mode, the condenser 53 may heat-exchange the refrigerant supplied from the compressor 52 with the first coolant supplied through the second connection line 43, to increase the temperature of the first coolant, so that the high-temperature first coolant is supplied to the heater core 32.

The first coolant heated while passing through the condenser 53 may be introduced into the heater core 32 along the second connection line 43 and the third line 31. The heater core 32 may heat-exchange the first coolant supplied from the condenser 53 with the ambient air, and may supply the heated ambient air to the vehicle interior.

Accordingly, the heater core 32 can rapidly increase the temperature of the vehicle interior, thereby enabling smooth heating.

The refrigerant discharged from the condenser 53 may be introduced into the sub-heat-exchanger 70 along the refrigerant line 51.

The refrigerant condensed in the condenser 53 may be secondarily condensed through heat-exchange with the refrigerant introduced from the refrigerant introduced from the evaporator 57 and the heat-exchanger 55 through the portion of the refrigerant line 51 and the second refrigerant connection line 63 while passing through the sub-heat-exchanger 70.

The refrigerant secondarily condensed in the sub-heat-exchanger 70 may be expanded in the first expansion valve 54. A partial refrigerant among the refrigerant expanded in the first expansion valve 54 may be introduced into the heat-exchanger 55, and remaining refrigerant may be introduced into the first refrigerant connection line 61.

The refrigerant introduced into the heat-exchanger 55 may be evaporated through heat-exchange with the ambient air. Accordingly, the heat-exchanger 55 may recollect the ambient air heat while evaporating the expanded refrigerant through heat-exchange with the ambient air.

The refrigerant discharged from the heat-exchanger 55 may pass through the second expansion valve 56, and then flow along the second refrigerant connection line 63.

The refrigerant introduced into the first refrigerant connection line 61 may be supplied to the evaporator 57 along the refrigerant line 51 connected to the evaporator 57.

In other words, the expanded refrigerant may be supplied to the evaporator 57 through the first refrigerant connection line 61. The evaporator 57 may recollect the ambient air heat while evaporating the expanded refrigerant through heat-exchange with the ambient air introduced into the HVAC module.

The refrigerant having passed through the evaporator 57 may pass through the sub-heat-exchanger 70 along the refrigerant line 51, to be then supplied to the accumulator 58, together with the refrigerant flowing through the second refrigerant connection line 63.

The refrigerant supplied to the accumulator 58 may be separated into gas and liquid, and the gaseous refrigerant among the refrigerant separated into gas and liquid may be introduced into the compressor 52.

In other words, the refrigerant discharged from the compressor 52 may flow along the opened refrigerant line 51, the first refrigerant connection line 61, and the second refrigerant connection line 63 to heat the vehicle interior, and may repeatedly perform the above-described operations, while sequentially passing through the condenser 53, the sub-heat-exchanger 70, the first expansion valve 54, the heat-exchanger 55, the second expansion valve 56, the evaporator 57, the sub-heat-exchanger 70, and the accumulator 58.

The ambient air introduced into the HVAC module may be dehumidified by the low-temperature refrigerant introduced into the evaporator 57 while passing through the evaporator 57. Thereafter, it is converted into a high-temperature state while passing through the heater core 32 and may be introduced into the vehicle interior, thereby smoothly heating and dehumidifying the vehicle interior.

In other words, a heat pump system according to an embodiment of the present disclosure may recollect the heat from the high-temperature refrigerant passing through the condenser 53, together with the ambient air heat, and use it for heating the vehicle interior, so that the power consumption of the compressor 52 may be reduced, and the heating efficiency may be improved.

In addition, the first coolant may be blocked from flowing to the engine 12, thereby rapidly warming up the engine 12.

In addition, in an embodiment of the present disclosure, the first expansion valve 54 may dividedly supply a partial refrigerant among the expanded refrigerant to the evaporator 57 through the first refrigerant connection line 61, and a remaining refrigerant to the heat-exchanger 55, so that a pressure drop of the refrigerant circulating along the refrigerant line 51 may be prevented.

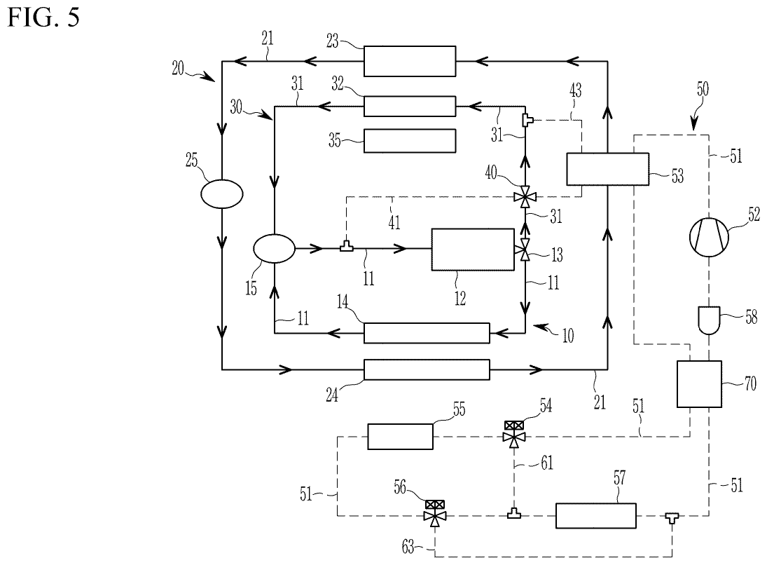

In addition, an operation for the heating mode of the vehicle interior is described in detail with reference to FIG. 5.

FIG. 5 is an operation diagram of a heat pump system for a hybrid vehicle according to an embodiment of the present disclosure, for the heating mode of the vehicle interior.

Referring to FIG. 5, the heat pump system may heat the vehicle interior in a state that the warming up of the engine 12 is completed.

The first cooling apparatus 10 may operate the first water pump 15 to circulate the first coolant through the first line 11, to cool the engine 12.

Accordingly, the first coolant cooled in the first radiator 14 may smoothly cool the engine 12.

The second cooling apparatus 20 may operate the second water pump 25 to circulate the second coolant through the second line 21 so as to cool the electrical component 23. Accordingly, the second coolant cooled in the second radiator 24 may smoothly cool the electrical component 23.

The control valve 40 may open the third line 31, and may close the first connection line 41 and the second connection line 43.

Accordingly, in the vehicle interior heating device 30, a partial first coolant among the first coolant having passed through the engine 12 may flow through the third line 31.

In other words, the first coolant heated while cooling the engine 12 may be supplied to the heater core 32 while circulating along the third line 31.

In addition, a remaining first coolant among the first coolant having passed through the engine 12 may be cooled through heat-exchange with the ambient air while passing through the first radiator 14 along the first line 11.

The first coolant cooled in the first radiator 14 may repeatedly perform the above-described operations.

The operation of the air conditioner unit 50 may be stopped.

Accordingly, the high-temperature first coolant supplied to the heater core 32 may increase the temperature of the ambient air introduced into the HVAC module. The heater core 32 can rapidly increase the temperature of the vehicle interior, thereby enabling smooth heating.

In other words, the ambient air introduced into the HVAC module may be introduced in an uncooled state of having been not cooled while passing through the evaporator 57 into which the refrigerant is not introduced. The introduced ambient air may be converted into a high-temperature state while passing through the heater core 32 and then introduced into the vehicle interior, thereby implementing heating of the vehicle interior.

In other words, a heat pump system according to an embodiment of the present disclosure can smoothly perform heating of the vehicle interior by using the waste heat generated from the engine 12, without the operation of the air conditioner unit 50.

Therefore, as described above, when a heat pump system for a hybrid vehicle according to an embodiment of the present disclosure is applied, by simultaneously perform the warming up of the engine 12 and heating of the vehicle interior in an early stage of driving the vehicle while the ambient air temperature is low, the engine 12 can be warmed up more rapidly, and the overall performance and efficiency of the system can be improved.

In addition, according to the present disclosure, the condenser 53 configured to heat-exchange the refrigerant supplied from the compressor 52 with at least one of the first coolant or the second coolant may be applied, and the coolant heated increased through heat-exchange with the refrigerant may be supplied to the heating device 30, so that the vehicle interior may be efficiently heated even before warming up the engine 12.

In addition, according to the present disclosure, by blocking the coolant from being introduced into the engine 12 when warming up the engine 12, the engine 12 can be warmed up more rapidly, so that the fuel efficiency can be improved by minimizing the operation of the engine 12 compared to the conventional scheme.

In addition, according to the present disclosure, in a heating-and-dehumidifying mode of the vehicle interior, by preventing a pressure drop of the refrigerant circulating along the refrigerant line 51, the operation efficiency of the system may be improved, so that the loss of the heating and dehumidification performance may be minimized.

In addition, according to the present disclosure, by using the coolant having recollected the heat of the engine 12 in heating of the vehicle interior, the heating performance may be further improved.

In addition, according to the present disclosure, by using the coolant having recollected the heat of the engine 12 in heating of the vehicle interior, without operating the air conditioner unit 50, the heating efficiency and performance may be further improved, and by minimizing the operation of the compressor 52, the unnecessary power consumption may be prevented.

In addition, according to the present disclosure, through streamlining of an entire system, it is possible to reduce manufacturing cost and weight and improve space utilization.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: engine cooling apparatus
11: first line
12: engine
13: engine valve
14: first radiator
15, 25: first and second water pumps
20: electrical component cooling apparatus
21: second line
23: electrical component
24: second radiator
30: heating device
31: third line
32: heater core
35: air heater
40: control valve
41: first connection line
43: second connection line
50: air conditioner unit
51: refrigerant line
52: compressor
53: condenser
54: first expansion valve
55: heat-exchanger
56: second expansion valve
57: evaporator
58: accumulator
61: first refrigerant connection line
63: second refrigerant connection line
70: sub-heat-exchanger

What is claimed is:

1. A heat pump system for a hybrid vehicle, the heat pump system comprising:
a first cooling apparatus including a first line along which a first coolant circulates,, an engine valve, a first radiator, and a first water pump, wherein the first line is configured to connect an engine, the engine valve, the first radiator, and the first water pump;
a second cooling apparatus including a second line along which a second coolant circulates, an electrical component, a second radiator, and a second water pump, wherein the second line is configured to connect the electrical component, the second radiator, and the second water pump;
a vehicle interior heating device including a third line having a first end connected to the engine valve and a second end connected to the first water pump to selectively circulate the first coolant, and a heater core provided on the third line;
a control valve provided on the third line between the engine valve and the heater core;
a first connection line including a first end connected to the control valve and a second end connected to the first line between the engine and the first water pump;
a second connection line including a first end connected to the control valve and a second end connected to the third line between the control valve and the heater core; and
an air conditioner unit including a refrigerant line along which a refrigerant circulates, a compressor, a condenser, a first expansion valve, a heat-exchanger, a second expansion valve, and an evaporator, wherein the refrigerant line is configured to connect the compressor, the condenser, the first expansion valve, the heat-exchanger, the second expansion valve, and the evaporator,
wherein the second line and the second connection line are connected to the condenser to selectively circulate the first coolant and the second coolant.

2. The heat pump system of claim 1, wherein:
the first expansion valve is provided on the refrigerant line between the condenser and the heat-exchanger; and
the second expansion valve is provided on the refrigerant line between the heat-exchanger and the evaporator.

3. The heat pump system of claim 2, comprising:
a first refrigerant connection line including a first end connected to the first expansion valve and a second end connected to the refrigerant line between the second expansion valve and the evaporator; and
a second refrigerant connection line including a first end connected to the second expansion valve and a second end connected to the refrigerant line between the evaporator and the compressor.

4. The heat pump system of claim 3, wherein, in a cooling mode of the vehicle interior, the first expansion valve is configured to close the first refrigerant connection line, and introduce the refrigerant supplied from the condenser into the heat-exchanger through the refrigerant line without expansion.

5. The heat pump system of claim 3, wherein, in a cooling mode of the vehicle interior, the second expansion valve is configured to close the second refrigerant connection line, expand the refrigerant supplied from the heat-exchanger, and introduce the refrigerant expanded by the second expansion valve to the evaporator through the refrigerant line.

6. The heat pump system of claim 3, wherein, in a vehicle interior heating-engine warm-up mode, the first expansion valve is configured to close the first refrigerant connection line, expand the refrigerant supplied from the condenser, and introduce the refrigerant expanded by the first expansion valve to the heat-exchanger through the refrigerant line.

7. The heat pump system of claim 3, wherein, when dehumidification is required in a vehicle interior heating-engine warm-up mode or in a vehicle interior heating-engine warm-up mode, the second expansion valve is configured to open the second refrigerant connection line, close the refrigerant line connected to the evaporator, and allow the refrigerant supplied from the heat-exchanger to flow along the second refrigerant connection line without expansion.

8. The heat pump system of claim 3, wherein, when dehumidification is required in a vehicle interior heating-engine warm-up mode, the first expansion valve is configured to open the first refrigerant connection line, expand the refrigerant supplied from the condenser, and allow the refrigerant expanded by the first expansion valve to flow along the refrigerant line and the first refrigerant connection line.

9. The heat pump system of claim 1, wherein, when dehumidification is required in a vehicle interior heating-engine warm-up mode or in a vehicle interior heating-engine warm-up mode, the engine valve is configured to close the first line connected to the first radiator so that the first coolant is not supplied to the engine.

10. The heat pump system of claim 1, wherein, when dehumidification is required in a vehicle interior heating-engine warm-up mode or in a vehicle interior heating-engine warm-up mode, the control valve is configured to open the first connection line and the second connection line so that the first connection line and the second connection line are connected, and close a portion of the third line connecting the engine valve and a second end of the second connection line.

11. The heat pump system of claim 1, wherein the control valve is configured to:
in a cooling mode of the vehicle interior, close the third line, the first connection line, and the second connection line; and
in a heating mode of the vehicle interior, open the third line, and close the first connection line and the second connection line.

12. The heat pump system of claim 1, wherein, in a heating mode of the vehicle interior when warming up of the engine is complete, the air conditioner unit is configured to stop operating.

13. The heat pump system of claim 1, wherein, in a vehicle interior heating-engine warm-up mode, the condenser exchanges heat between the refrigerant supplied from the compressor and the first coolant supplied through the second connection line, to increase temperature of the first coolant, so that the first coolant is supplied to the heater core.

14. The heat pump system of claim 1, wherein the first expansion valve and the second expansion valve are 3-way electronic expansion valves configured to selectively expand the refrigerant while controlling a flow movement of the refrigerant.

15. The heat pump system of claim 1, wherein an accumulator is provided on the refrigerant line between the evaporator and the compressor.

16. The heat pump system of claim 1, further comprising a sub-heat-exchanger provided on the refrigerant line connecting the condenser and the first expansion valve, and the refrigerant line connecting the evaporator and the compressor, wherein the sub-heat-exchanger is configured to exchange heat between the refrigerant supplied from the condenser through the refrigerant line, and the refrigerant supplied from the evaporator.

17. The heat pump system of claim 1, wherein the heater core is an air-cooled heat-exchanger configured to:
in a vehicle interior heating-engine warm-up mode, exchange heat between the first coolant supplied from the condenser with an ambient air, and supply the heated ambient air to the vehicle interior; and
in a heating mode of the vehicle interior, exchange heat between the first coolant supplied from the engine with the ambient air, and supply the heated ambient air to the vehicle interior.

18. The heat pump system of claim 1, wherein:
the condenser is a water-cooled heat-exchanger; and
the heat-exchanger is an air-cooled heat-exchanger.

19. The heat pump system of claim 1, wherein the heat-exchanger is configured to condense or evaporate the refrigerant through exchanging heat with an ambient air, according to a selective operation of the first expansion valve.

20. The heat pump system of claim 1, wherein the control valve is a 4-way valve configured to control a flow rate distribution and a flow movement of the supplied first coolant.
